(19) United States
(12) Patent Application Publication
(10) Pub. No.: US 2020/0174474 A1
(43) Pub. Date: Jun. 4, 2020

(54) METHOD AND SYSTEM FOR CONTEXT AND CONTENT AWARE SENSOR IN A VEHICLE

(71) Applicant: Zuragon Sweden AB, Danderyd (SE)

(72) Inventors: Joachim FRITZSON, Javea (ES); Siamak KHATIBI, Rodeby (SE)

(21) Appl. No.: 16/696,032

(22) Filed: Nov. 26, 2019

(30) Foreign Application Priority Data
Nov. 30, 2018 (SE) 1851493-5

(51) Int. Cl. G05D 1/00; B60W 40/04; G06K 9/00; G06K 9/62

(52) U.S. Cl. CPC G05D 1/0088; B60W 40/04; G06K 9/00791; G05D 2201/0213; B60W 2550/20; B60W 2420/42; B60W 2420/52; G06K 9/6267

(57) ABSTRACT

A method for sampling of task relevant data in sensors in a vehicle, wherein a number of sensors are arranged in the vehicle. The method comprises receiving a task at a computer or data processing unit arranged in the vehicle, the task being associated with task information, providing a set of abstract models associated with context and content information, the abstract models including models describing traffic scenes and the context and context information describing traffic scene environment, classifying sampling of sensor data according to the task information and a selected abstract model in order to sample task relevant data, evaluating the selected abstract model based on received sensor data whether to maintain the selected abstract model or to select a new abstract model, the received sensor data representing an actual traffic scene, and adapting the classification of sampling of sensor data based on selected abstract model.

### CROSS-REFERENCE TO RELATED APPLICATION

This Application is related to and claims priority to Swedish Application No. 1851493-5, filed Nov. 30, 2018, the entire contents of which is incorporated herein by reference.

### TECHNICAL FIELD

The present invention generally relates to the field of autonomous vehicles and vehicle control systems for efficient handling of sensor data in autonomous vehicles.

### BACKGROUND ART

Vehicles, such as driverless cars, can include systems, such as sensors, cameras, etc. that generate enormous amounts of data that are sent to the vehicle control system. Driverless cars can operate autonomously in many situations. Sensor's, cameras, and other units of the car thus provide input to the vehicle's control system and the control system operate the vehicle autonomously based on the provided input. One example of a vehicle control system that is becoming increasingly popular is Advanced Driver Assistance System systems, “ADAS” systems. ADAS systems provide one or more autonomous features to the vehicles which include these ADAS systems. For example, an ADAS system may monitor the position of the vehicle relative to the lane in which the vehicle is travelling and if the vehicle begins to swerve outside that lane the ADAS system may take remedial action by repositioning the vehicle so that the vehicle stays in the lane or providing a notification to the driver informing the driver of the situation.

Hence, the vehicles today, in particular driverless cars, includes sensors or detection units such as one or more cameras, one or more LIDARs, one or more radar sensors, etc. which simultaneously provides input to the ADAS system over a network. The ADAS system continuously makes decisions regarding situations, e.g. degree of seriousness, and sends control signals based on the decisions to different units of the vehicle. For example, the ADAS system may send control signals to the braking system of the vehicle and/or steering system of the vehicle to avoid a collision or to navigate the vehicle in a traffic situation.

Due to the complexity of the traffic environment and the increasing number of sensors in vehicles (for example, a vehicle will very likely have up to 10-15 cameras in the near future), the amount of data delivered into the ADAS systems is huge and will continue to increase. In order to extract the relevant information from an actual scene, which undergoes different complex traffic scenarios, and to detect the important objects, for example, another vehicle having a collision course toward the actual vehicle, huge amounts of data has to be analysed. This, in turn, entails an increasing need for higher bandwidth in the internal networks of the vehicle and higher processing capacity in the ADAS systems for example.

These demands are becoming increasingly more pronounced due to the desire for a higher degree of autonomy of the vehicles and thereto linked higher security requirements, the increased number of sensors in the vehicles and the increased traffic intensity. Hence, there is a need within the business of systems and methods that can handle the above-mentioned problems.

### SUMMARY OF THE INVENTION

According to an object of the present invention, there is provided improved methods and systems for efficient handling of data from sensors in a vehicle.

According to another object of the present invention, there is provided improved methods and systems for reducing used memory resources and reduced usage of processing power in autonomous vehicles.

On a general level, the present invention the method and system senses/samples task relevant information from an actual scene which undergoes different vehicle traffic senarios. A scene information can be represented by different level of data abstraction from no-abstruction (pure data) to high abstraction. A high data abstraction is used where semantic rules of perception drive the abstraction process. For example, it can be assumed a shopping mall. The pure data can be sensed by different devices to enable navigation in the mall; this data can be huge in relation to sensor devices and their resolutions. The high semantic abstraction of the same data which is used in the present invention is represented just by four normal vectors of the scene walls.

By implementing the present invention, an actual scen data can be sampled by different types and number of devices such as camera, Lidar and etcetra. If the sampling devices have open strategy it is possible to allocate and plan the sampling points and if the devices are closed then their data is processed in to reduce the amount of data in relation to specific tasks such as navigation and detection.

The present invention uses the human perception process to find the relative data according to the task. Like human perception the present invention, use simple models av geometrical scenes (i.e. the abstraction models) and have learning and dreaming process where in learning the significancy of the past models are learned and in dreaming new combination of learned models are simulated.

According to an aspect of the present invention, a method for sampling of task relevant data in sensors in a vehicle, wherein a number of sensors are arranged in the vehicle. The method comprises receiving a task at a computer or data processing unit arranged in the vehicle, the task being associated with task information, providing a set of abstract models associated with context and content information, the abstract models including models describing traffic scenes and the context and content information describing traffic scene environment, classifying sampling of sensor data according to the task information and a selected abstract model in order to sample task relevant data, evaluating the selected abstract model based on received sensor data whether to maintain the selected abstract model or to select a new abstract model, the received sensor data representing an actual traffic scene, and adapting the classification of sampling of sensor data based on selected abstract model.

In an aspect of the present invention, there is provided a system for sampling of task relevant data in sensors in a vehicle, wherein a number of sensors are arranged in the vehicle, comprising: a data processing unit arranged in the vehicle, wherein the data processing unit is configured to receive tasks, each task being associated with task information, the data processing unit being configured to classify sampling of sensor data according to task information and a selected abstract model in order to sample task relevant data, wherein an abstract model is selected from a set of abstract models associated with context and content information, the abstract models including models describing traffic scenes and the context and content information describing traffic scene environment. The data processing unit is further configured to evaluate the selected abstract model based on received sensor data whether to maintain the selected abstract model or to select a new abstract model, the received sensor data representing an actual traffic scene, and to adapt the classification of sampling of sensor data based on selected abstract model.

According to embodiments of the present invention, the sensors may, for example, include one or more cameras, one or more LIDAR, and one or more radar units, one or more V2X sensors (Vehicle-to-everything sensors), and one or more ultrasonic sensors.

A computer, or data processing unit or electronic control unit may be configured to receive tasks, each task being associated with task information. A task may for example be navigation to a certain location, area or place, e.g. defined by map coordinates and GPS coordinates. The task information may be information related to the task and required to solve the task. For example, it may be coordinates, or information related to available roads, barriers along the road. The task relevant data is data from sensors that is relevant to an ongoing task and may be added to the task relevant information. For example, it may be information that describes the roadway environment outside the vehicle, the location of remote vehicles, objects in the roadway or in the surroundings of the roadway relative the vehicle, operational status of the vehicle (e.g. kinematic data for the vehicle), map data and GPS data. In some embodiments, the operational status of the vehicle is information in the sensor data that described one or more of the following. Kinematic data for the vehicle, the latitude and longitude of the vehicle, the heading of the vehicle, braking system data (e.g. whether brakes are engaged), the elevation of the vehicle, the current time for the vehicle, the speed of the vehicle, the steering angle of the vehicle, the acceleration of the vehicle, the path history of the vehicle, an estimate of the further path of the vehicle. The GPS data may include digital data that describes the geographic location of the vehicle, for example, latitude and longitude with lane-level accuracy. The map data may include digital data that describes, for different combinations of latitude and longitude as indicated by GPS data, different geographical features of the roadway environment indicated by the GPS data such as the presence of curves in the roadway, whether this is a bumpy road, the average vehicular speeds along the roadway at different times of day etc.

The present invention provides a number of advantages. For example, the used or required processor power can be reduced significantly since only small parts of a sensors available pixels are sampled in each frame and distributed further to the processing units of the vehicle. This is due to the classification of the sampling points in the sensors where only pixels relevant for an assigned task are sampled.

Another advantage is that a reaction time on a detected deviation, for example, an animal or other vehicle in front, can be improved, i.e. less data results to faster dataprocessing which in its turn results to faster reaction time.

The used memory capacity can also be reduced since only data relevant for the task need to be stored.

The reduced usage of memory capacity and reduced usage of processing power also entail to reduced power consumption.

A further advantage is smaller amounts of data needs to be transferred from the vehicle to external units, such as servers and/or cloud based solutions, as we as to other vehicles.

In embodiments of the present invention, task information is provided to a control unit of the vehicle, for example, the ECU, which may send instructions to different other units or systems of the vehicle such as to the the braking system and/or steerings system. This step can be executed in connection with other step of the method or control loop and/or continuously during the execution of the method or control loop.

In embodiments of the present invention, the context and content information of the abstract models is updated with data from task relevant data.

According to embodiments of the present invention, the abstract models are stored locally in sensors of the vehicle, and/or in a memory of the data processing unit, and/or in a memory of the electronic control unit and/or externally of the vehicle in a server based memory or cloud based memory.

In embodiments of the present invention, there is provided a system for sampling of task relevant data in sensors in a vehicle, wherein a number of sensors are arranged in the vehicle. At least one sensor includes a data processing unit, wherein the data processing unit is configured to receive tasks, each task being associated with task information. The sensor data processing unit is configured to classify sampling of sensor data according to task information and a selected abstract model in order to sample task relevant data, wherein an abstract model is selected from a set of abstract models associated with context and content information, the abstract models including models describing traffic scenes and the context and content information describing traffic scene environment. Further, the sensor data processing unit is configured to evaluate the selected abstract model based on sensor data whether to maintain the selected abstract model or to select a new abstract model, wherein the sensor data representing an actual traffic scene, and to adapt the classification of sampling of sensor data based on selected abstract model.

According to an embodiment of the present invention, there is provided a sensor for sampling of task relevant data in a vehicle including a data processing unit, wherein the data processing unit is configured to receive tasks, each task being associated with task information. The sensor data processing unit is configured to classify sampling of sensor data according to task information and a selected abstract model in order to sample task relevant data, wherein an abstract model is selected from a set of abstract models associated with context and content information, the abstract models including models describing traffic scenes and the context and context information describing traffic scene environment; and the sensor data processing unit is configured to evaluate the selected abstract model based on sensor data whether to maintain the selected abstract model or to select a new abstract model, the sensor data representing an actual traffic scene, and to adapt the classification of sampling of sensor data based on selected abstract model.

As the skilled person realizes, steps of the methods according to the present invention, as well as preferred embodiments thereof, are suitable to realize as computer program or as a computer readable medium.

Further objects and advantages of the present invention will be discussed below by means of exemplifying embodiments.

### BRIEF DESCRIPTION OF THE DRAWINGS

Exemplifying embodiments of the invention will be described below with reference to the accompanying drawings, in which:

FIG. 1 is a schematic block diagram illustrating a vehicle including the system and elements according to an embodiment of the present invention;

FIG. 2 is a schematic block diagram illustrating the system according to embodiments of the present invention;

FIG. 3 is a schematic flow diagram showing steps of a method according to the present invention;

FIG. 4 is a schematic flow diagram showing steps of a method according to the present invention;

FIG. 5 is a schematic flow diagram showing steps of a method according to the present invention;

FIGS. 6a and 6b is schematic diagram showing examples of abstract models;

FIG. 7 is a schematic block diagram illustrating a vehicle including the system and elements according to an embodiment of the present invention; and

FIG. 8 is a schematic flow diagram showing steps of a method according to the present invention.

### DESCRIPTION OF EXEMPLIFYING EMBODIMENTS

The following is a description of exemplifying embodiments in accordance with the present invention. This description is not to be taken in limiting sense, but is made merely for the purposes of describing the general principles of the invention.

Thus, preferred embodiments of the present invention will now be described for the purpose of exemplification with reference to the accompanying drawings, wherein like numerals indicate the same elements throughout the views. It should be understood that the present invention encompasses other exemplary embodiments that comprise combinations of features as described in the following. Additionally, other exemplary embodiments of the present invention are defined in the appended claims.

First, the ADAS system will be described in general terms. An ADAS system may include one or more of the following elements of a vehicle: an adaptive cruise control (“ACC”); an adaptive high beam system; an adaptive light control system; an automatic parking system; an automotive night vision system; a blind spot monitor; a collision avoidance system (sometimes called a pre-collision system or a “PCS”); a crosswind stabilization system; a driver drawsiness detection system; a driver monitoring system; an emergency driver assistance system; a forward collision warning system; an intelligent speed adaptation system; a lane departure warning system (sometimes called a lane keep assist system or “LKA”); a pedestrian protection system; a traffic sign recognition system; a turning assistant; and a wrong-way driving warning system. The ADAS system may also include any software or hardware included in the vehicle that makes the vehicle be an autonomous vehicle or semi-autonomous vehicle.

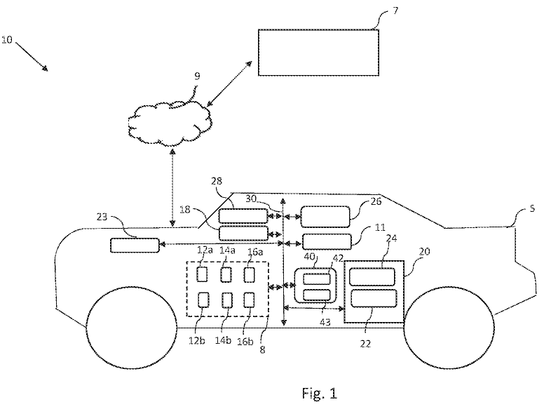

Referring now to FIG. 1, an operating environment 10 for the present invention. The operating environment 10 is implemented in a vehicle 5 and a server 7 located externally of the vehicle 5 or a cloud based solution 7 located externally of the vehicle 5.

These elements may be communicatively connected or coupled to a network 9. Although only one vehicle 5 and one server or cloud based solution and one network 9 are shown in FIG. 1, in practice the operating environment may include more vehicles, servers and networks. The network 9 may be a conventional type, wired or wireless, and may have numerous different configurations including a star configuration, token ring configuration or ther configurations. Furthermore, the network 9 may also include a wide area network (WAN) (e.g. the Internet), a local area network (LAN), or other interconnected data paths across which multiple device and entities may communicate. The network 9 may also be coupled to or may include portions of telecommunications networks for sending data in a variety of different protocols. For example, the network 9 may include Bluetooth® communication networks or cellular communications networks for sending or receiving data including data including via short messaging service (SMS), hypertext transfer protocol (HTTP), direct data connection, wireless application protocol (WAP), multimedia messaging service (MMS), e-amil, DSRC, full-duplex wireless communication, etc. Further, the network may also include a mobile data network that may include 3G, 4G, LTE, VoLTE or any other cellular network, mobile data network or combination of mobile data networks. The network 9 may also include one or more IEEE 802.11 wireless networks.

The vehicle 5 may include a car, a truck, a sports utility vehicle (SUV), a bus, a semi-truck, adrone, or any other roadway-based conveyance. A road-based conveyance is hardware device that traverses the top surface of a roadway.

In embodiments, the vehicle 5 may include an autonomous vehicle, a semi-autonomous vehicle or Highly Automated Vehicle (“HAV”). For example, the vehicle 5 may include an ADAS system 11 which is operable to make the vehicle 5 an autonomous vehicle. An HAV is a vehicle 5 whose ADAS system 11 operate at level 3 or higher as defined by the NHTSA in the policy paper “Federal Automated Vehicles Policy: Accelerating the Next Revolution in Road-way safety”, published in September 2016.

The vehicle 5 may further include a sensor set 8 comprising camera sensors 12a and 12b, one or more LIDAR sensors 14a and 14b, and one or more radar sensors 16a and 16b. In the present example, two camera sensors, two LIDAR senors, and two radar sensors are shown. However, any number of sensors may be included and a vehicle may often have 10-15 camera sensors as an example. It should also be understood that the location of the sensors in the figures only are schematical, i.e. for illustrative purposes only, and may be located at any suitable location in the vehicle 5 in order to satisfy its functions and purposes.

Furthermore, the vehicle 5 may include an acuator set 18, a hardware ECU 20, a communication unit 26, and GPS unit 28. The ECU 20 in turn include a processor 22, and a memory 24. These elements of the vehicle 5 is communicatively coupled to one another via a bus 30. The memory 24 may be a non-transitory computer readable memory. The memory 24 stores instructions or data that can be executed by the processor 22. The instructions or data contain code for performing the techniques described herein. In some embodiments the memory 24 may be a dynamic random access memory (DRAM) device, a static random access memory (SRAM) device, flash memory, or some other memory device. In some embodiments, the memory 24 also includes a non-volatile memory or similar permanent storage device and media including a hard disk drive, a floppy disk drive, a CD-ROM device, a DVD-ROM device, a DVD-RAM device, a DVD-RW device, a flash memory device or some other mass storage device for storing information on a more permanent basis.

The actuator set 18 includes one or more actuators of the vehicle 5. For example, the actuator set 18 includes one or more of the following: one or more hydraulic actuators, one or more electric actuators and one or more thermal actuators.

The processor 22 may include an arithmetic logic unit, a microprocessor, a general purpose controller or some other other processor array to perform computations and provide electronic display signals to a display device. The processor 22 processes data signals and may include various computing architectures including a complex instructions set computer (“CISC”) architecture, a reduced instruction set computer (“RISC”) architecture or an architecture implementing a combination of instructions sets. Although FIG. 1 shows a single processor in the ECU multiple processors may be included. The processor 22 may include a sensor fusion processor for merging sensor data from different sensors 8. The sensor set 8 includes camera sensors 12a, 12b, LIDAR sensors 14a, 14b and radar sensors 16a, 16b. However, it may further include millimeter wave radar, a speed sensor, a laser altimeter, a navigation sensor (e.g. a global positioning system sensor of the GPS unit), an infrared detector, a motion detector, an automobile engine sensor, a valve timer, an air-fuel ratio meter, a thermostat, a sound detector, a carbon monoxide detector, an oxygen sensor, a mass air flow sensor, an engine coolant temperature sensor, a blind spot meter, a curb feeler, a defect meter, a Hall effect sensor, a manifold absolute pressure sensor, a parking sensor, a radar gun, a speedometer, a transmission fluid temperature sensor, a turbine speed sensor, a variable reluctance sensor, a wheel speed sensor, and any type of automotive sensor that may be present in an HAV.

The sensor set 8 may be operable to record data (hereinafter “sensor data”) that described one or more measurements of the sensors included in the sensor set 8.

As indicated above, the sensor set 8 include sensors that are operable to measure the physical environment outside the vehicle 5. For example, the sensor set 8 may record one or more physical characteristics of the physical environment that is proximate to the vehicle 5. The measurements recorded by the sensors are described by sensor data stored in the memory 24.

The sensor data may describe the physical environment proximate to the vehicle at one or more times. The sensor data may be timestamped by the sensors of the sensor set 8.

The sensor set 8 includes as, described above, sensors 12a, 12b, 14a, 14b, 16a, and 16b that are operational to measure, among other things: the physical environment, or roadway environment where the vehicle 5 is located as well as the static objects within this physical environment, the dynamic objects within the physical environment and the behaviour of these objects, the position of the vehicle 5 relative to static and dynamic objects within the physical environment (e.g. as recorded by one or more of range-finding sensors such as LIDAR) and the weather within the physical environment over time and other natural phenomena within the physical environment over time, coefficients of friction and other variables describing objects.

The communication unit 26 transmits and receives data to and from the network 9 or to another communication channel. In some embodiments, the communication unit 26 may include a DSRC transceiver, DSRC receiver and to the hardware or software necessary to make the vehicle 5 a DSRC-enabled device.

In embodiments of the present invention, the communication unit 26 includes a port for direct physical connection to the network 9 or to another communication channel. For example, the communication unit 26 includes a USB, SD, CAT-5, or similar port for wired communication with the network 9. In some embodiments, the communication unit 26 includes a wireless transceiver for exchanging data with the network 9 or other communication channel using one or more wireless communication methods, including IEEE 802.11; IEEE 802.16, BLUETOOTH®, EN ISO 14906:2004 Electronic Fee Collection Application interface EN 11253:2004 Dedicated Short-Range Communication—Physical Layer using microwave at 5.8 GHz (review); EN 12795:2002 Dedicated Short-Range Communication (DSRC)—DSRC data link layer: Medium Access and logical link control (review); EN 12834:2002 Dedicated Short-Range Communciation—Application layer (review); EN 13372:2004 Dedicated Short-Range Communication (DSRC)—DSRC profiles for RTTT applications (review).

In some embodiments, the communication unit 26 includes a cellular communication transceiver for sending and receiving data over a cellular communications network including via short messaging service (SMS), multimedia messaging service (MMS), hypertext transfer protocol (“HTTP” or “HTTPS” if the secured implementation of HTTP is used), direct data connection, WAP, email or any other suitable type of electronic communication. In some embodiments, the communication unit 26 also provides other conventional connections to the network 9 for distribution of files or media using standard network protocols including TCP/IP, HTTP, HTTPS and SMTP, millimeter wave, DSRC, etc.

The vehicle further includes one or more driving systems 23, such as, braking system and steering system 23.

A data processing unit 40 is arranged in the vehicle 5 and may be communicatively coupled to, via the bus 30, with the sensors 8 and the electronic control unit 20, as well as to other units of the vehicle such as the GPS unit 28 and communication unit 26.

The data processing unit 40 may include a processor 43, such as an arithmetic logic unit, a microprocessor, a general purpose controller or some other other processor array to perform computations and provide electronic display signals to a display device. The processor 43 may include a sensor fusion processor for merging sensor data from different sensors.

The data processing unit 40 processes data signals and may include various computing architectures including a complex instructions set computer (“CISC”) architecture, a reduced instruction set computer (“RISC”) architecture or an architecture implementing a combination of instructions sets. The data processing unit 40 may further include a memory 42. The memory 42 may be a non-transitory computer readable memory. The memory 42 stores instructions or data that can be executed by the data processing unit 40. The instructions or data contain code for performing the techniques described herein. In some embodiments the memory 42 may be a dynamic random access memory (DRAM) device, a static random access memory (SRAM) device, flash memory, or some other memory device. In some embodiments, the memory 42 also includes a non-volatile memory or similar permanent storage device and media including a hard disk drive, a floppy disk drive, a CD-ROM device, a DVD-ROM device, a DVD-RAM device, a DVD-RW device, a flash memory device or some other mass storage device for storing information on a more permanent basis.

The data processing unit 40 may be configured to receive tasks, each task being associated with task information. A task may for example be navigation to a certain location, area or place, e.g. defined by map coordinates and GPS coordinates. The task information may be information related to the task and needed to solve the task. For example, it may be coordinates, or information related to available roads, barriers along the road. The task relevant data is data from sensors that is relevant to an ongoing task and may be added to the task relevant information. For example, it may be information that describes the roadway environment outside the vehicle 5, the location of remote vehicles, objects in the roadway or in the surroundings of the roadway relative the vehicle 5, operational status of the vehicle 5 (e.g. kinematic data for the vehicle 5), map data and GPS data.

In some embodiments, the operational status of the vehicle 5 is information in the sensor data that described one or more of the following. Kinematic data for the vehicle, the latitude and longitude of the vehicle, the heading of the vehicle, braking system data (e.g. whether breaks are engaged), the elevation of the vehicle, the current time for the vehicle, the speed of the vehicle, the steering angle of the vehicle, the acceleration of the vehicle, the path history of the vehicle, an estimate of the further path of the vehicle.

The GPS data may include digital data that describes the geographic location of the vehicle, for example, latitude and longitude with lane-level accuracy.

The map data may include digital data that describes, for different combinations of latitude and longitude as indicated by GPS data, different geographical features of the roadway environment indicated by the GPS data such as the presence of curves in the roadway, whether this is a bumpy road, the average vehicular speeds along the roadway at different times of day etc.

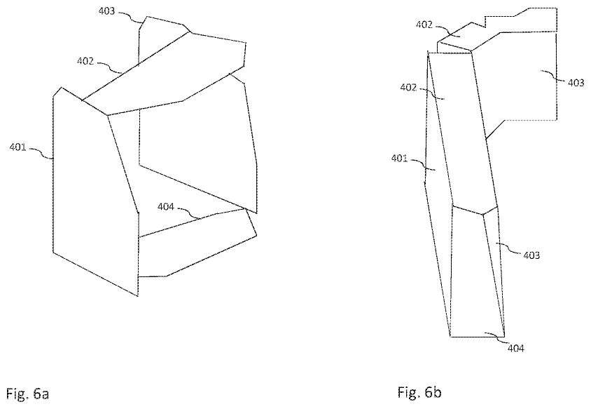

Abstract model is a simplified model or description of a scene or environment based on vectors or surfaces. The abstract model may contain information about the scene, context information. In case of a road, it may be, for example, type of road. Further, the abstract model may include content information, which, in case of the road, may be information about bends, and/or crossings. In FIGS. 6a and 6b, examples of such abstract models are shown. FIG. 6a shows an abstract model put together of four surfaces or planes 401, 402, 403, and 404. FIG. 6b shows another example, put together of a number of surfaces or planes 401, 402, 403, and 404 shown in FIG. 6a. The planes or surfaces are formed from sensors data or information from one or several sensors and location information.

The data processing unit 40 may further be configured to classify sampling of sensor data according to task information and a selected abstract model in order to sample task relevant data, wherein an abstract model is selected from a set of abstract models associated with context and content information, the abstract models including models describing traffic scenes and the context and context information describing traffic scene environment. Moreover, the data processing unit 40 is configured to evaluate the selected abstract model based on received sensor data whether to maintain the selected abstract model or to select a new abstract model, the received sensor data representing an actual traffic scene, and to adapt the classification of sampling of sensor data based on selected abstract model.

The data processing unit 40 is configured to continuously collect task relevant data based on received sensor data, adding the task relevant data to the task information and providing task information to an electronic control unit 20 of the vehicle 5. Further, the data processing unit 40 may be configured to update the context and content information of the abstract models with data from task relevant data.

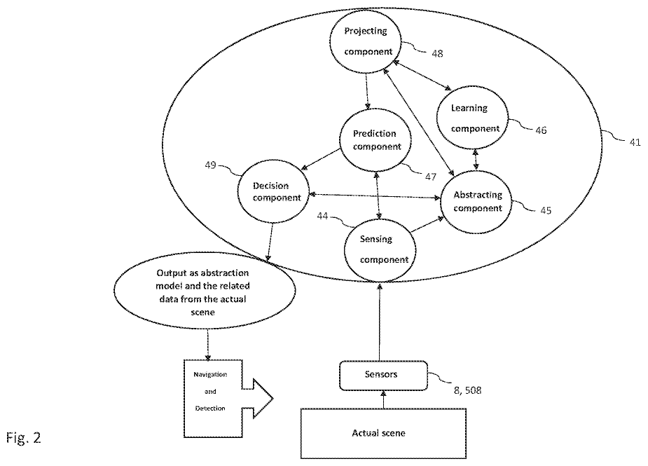

The data processing unit 40 comprises a sensor data handling module 41 including six main components 44-49, as shown in FIG. 2, and which will be described hereinafter.

The main components are provided or implemented in the processor 43 and/or memory 42 of the data processing unit 40. The main components may in embodiments be distributed over different units, parts and systems of the vehicle 5. For example, in the data processing 40 and the sensors 8. The sensing component 44 may for example be distributed in the sensors 8.

The components include a sensing component 44, an abstracting component 45, a learning component 46, a prediction component 47, a projecting component 48, and a decision component 49 which have direct or indirect interaction with each other.

Below, each component's roll and the interaction between them will be discussed. It should be noted that each component may have different elements as operational units.

Sensing Component: the component may communicate directly with several of the same or different sensing devices 8; e.g. camera/cameras, Lidar, Ultrasound. In case of closed devices (i.e. not have opertunity to interact with the device sampling) the output of sensing component is pure data otherwise the data is chosen in interaction to other components.

Abstracting Component: the component may include several of the same or different elements where each element has information of a surface form; e.g. flat surfaces or/and different types of non-flat surfaces. Generally the elements are categorized in three levels of low, mid and high abstraction levels. In the abstracting component either the data (e.g. pure data) are used or the predefined models of elements are refined to obtain the elements.

Learning Component: the component have two major sub-component of frame learning and chain learning. In frame learning the elements of the abstracting component of each actual scene are used to learn a set of parameters related to combination of elements; e.g. scaling, angle, . . . . In chain learning there are three elements of short, mid and long chain learning. Generally in the chain learning the short, mid and long memory of scenes are used to learn a set of parameters related to the changes of combination of elements. In this component external available resources like as GPS, map data, videos and etcetra are used for both sub-components of frame and chain learning.

Prediction Component: the component has two major sub-components of generation and quality evaluation. The sub-component of generation has two major elements of surface generation and surface model (i.e. of combined surfaces) generation. Generally the seed of generation process is initiated by the learning component in combination of random processes. The sub-component of quality evaluation uses a quality matris to evaluate (accept, partially accept or reject) the generation result. The quality matris is build upon learning component parameters and physical quality parameters related to the quality space of rational physical geometry in two-dimensional manifolds.

Projecting Component: the component has two elements of search and match elements. Generally the abstraction component, learning component and prediction component provides certain numbers of abstraction models to this component which further the elements of search and match are used to project the abstracted models to the current scene. The two elements of search and match work interactively in an iteration process.

Decision Component: The component uses an element of statistical classification to determine the need of new abstraction modelling fran result of the projecting component. Generally, the projecting component attempts to find the best available abstraction model (i.e. from available models in the learning component and prediction component) to current scene. In the 2-dimensional manifolds space, a set of evaluation parameters are found which represent the goodness of projected abstraction model to the actual scene. Each of such evaluation parameter has local and global distribution (i.e. from current situation and past times). The statistical model for the classification is formed by join distribution of evaluation parameters.

The output of the sensor data handling module 41 is an abstraction model of the actual scene and the related data in relation to the surfaces obtained by the abstraction model.

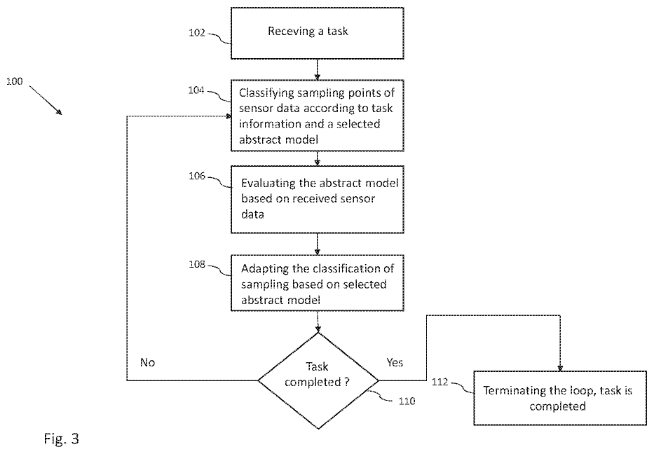

With reference now to FIG. 3, a flow chart describing a method or control loop 100 according to embodiments of the present invention will be discussed. The steps taking place in the sensor data handling module 41 and its components (described above with reference to FIG. 2) according to an example embodiment of the present invention are accordingly illustrated in FIG. 3

At step 102, a task is received, which may be navigating the vehicle 5 to a certain location. For example, it may be a passenger of the vehicle 5 entering the task into a monitor module of the vehicle 5. At step 104, sampling of sensor data is classified according to the task information and a selected abstract model in order to sample task relevant data, wherein the selected abstract model is selected from a set of abstract models associated with context and content information, the abstract models including models describing traffic scenes and the context and context information describing traffic scene environment. The abstract models are stored locally in sensors 8 of the vehicle, and/or in a memory 42 of the data processing unit 40, and/or in a memory 24 of the electronic control unit 20 and/or externally of the vehicle in a server based memory 7 or cloud based memory 7.

Depending upon the received sensor data, the sampling in the sensors 8 can be increased, maintained or decreased. For example, in case of an alert situation, e.g. an animal is detected in front of the vehicle, the sampling needs to be increased drastically. Another example, is when the vehicle travels on a roadway in a desert landscape without any objects at all present, the sampling can be kept at minimum, for example, instead of 1000 pixels (which is the full size of the example sensor), 10-15 pixels can be sampled. Thereafter, at step 106, the selected abstract model is evaluated based on received sensor data in order to decide whether to maintain the selected abstract model or to select a new abstract model, the received sensor data representing an actual traffic scene. At step 108, the classification of sampling of sensor data is adapted based on selected abstract model. Thereafter, the control loop 100 determines, at step 110, if the task has been completed or accomplished, if not, the loop 100 returns to step 104. If yes, the control loop 100, closes or terminates the task, at step 112.

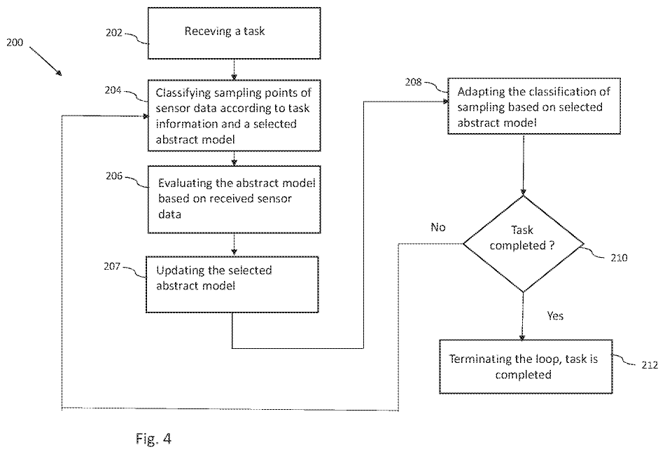

With reference now to FIG. 4, a flow chart describing a method or control loop 200 according to embodiments of the present invention will be discussed. The steps taking place in the sensor data handling module 41 and its components (described above with reference to FIG. 2) according to an example embodiment of the present invention are accordingly illustrated in FIG. 4.

At step 202, a task is received, which may be navigating the vehicle 5 to a certain location. For example, it may be a passenger of the vehicle 5 entering the task into a monitor module of the vehicle 5. At step 204, sampling of sensor data is classified according to the task information and a selected abstract model in order to sample task relevant data, wherein the selected abstract model is selected from a set of abstract models associated with context and content information, the abstract models including models describing traffic scenes and the context and context information describing traffic scene environment. The abstract models are stored locally in sensors 8 of the vehicle, and/or in a memory 42 of the data processing unit 40, and/or in a memory 24 of the electronic control unit 20 and/or externally of the vehicle in a server based memory 7 or cloud based memory 7.

Thereafter, at step 206, the selected abstract model is evaluated based on received sensor data in order to decide whether to maintain the selected abstract model or to select a new abstract model, the received sensor data representing an actual traffic scene.

At step 207, the selected abstract model is updated, i.e the context and content information of the abstract models is updated with data from received sensor data, for example, with task relevant data.

At step 208, the classification of sampling of sensor data is adapted based on selected abstract model. Thereafter, the control loop 200 determines, at step 210, if the task has been completed or accomplished, if not, the loop 200 returns to step 204. If yes, the control loop 200, closes or terminates the task, at step 212.

Depending upon the received sensor data, the sampling in the sensors 8 can be increased, maintained or decreased. For example, in case of an alert situation, e.g. an animal is detected in front of the vehicle, the sampling needs to be increased drastically. Another example, is when the vehicle travels on a roadway in a desert landscape without any objects at all present, the sampling can be kept at minimum, for example, instead of 1000 pixels (which is the full size of the example sensor), 10-15 pixels can be sampled.

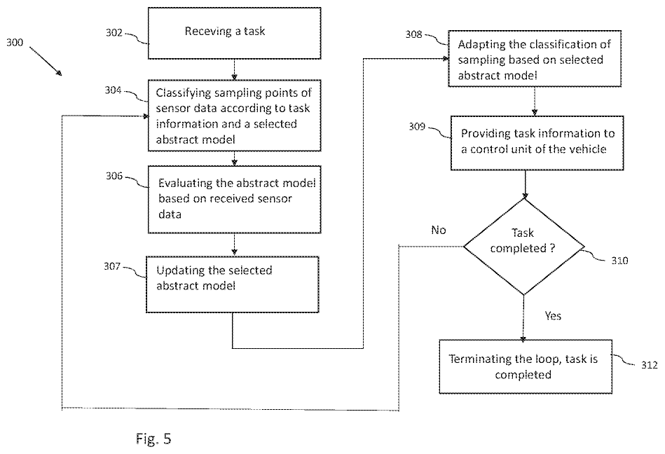

Turning now to FIG. 5, a flow chart describing a method or control loop 300 according to embodiments of the present invention will be discussed. The steps taking place in the sensor data handling module 41 and its components (described above with reference to FIG. 2) according to an example embodiment of the present invention are accordingly illustrated in FIG. 3.

At step 302, a task is received, which may be navigating the vehicle 5 to a certain location. For example, it may be a passenger of the vehicle 5 entering the task into a monitor module of the vehicle 5.

At step 304, sampling of sensor data is classified according to the task information and a selected abstract model in order to sample task relevant data, wherein the selected abstract model is selected from a set of abstract models associated with context and content information, the abstract models including models describing traffic scenes and the context and context information describing traffic scene environment.

Thereafter, at step 306, the selected abstract model is evaluated based on received sensor data in order to decide whether to maintain the selected abstract model or to select a new abstract model, the received sensor data representing an actual traffic scene. The abstract models are stored locally in sensors 8 of the vehicle, and/or in a memory 42 of the data processing unit 40, and/or in a memory 24 of the electronic control unit 20 and/or externally of the vehicle in a server based memory 7 or cloud based memory 7.

Depending upon the received sensor data, the sampling in the sensors 8 can be increased, maintained or decreased. For example, in case of an alert situation, e.g. an animal is detected in front of the vehicle, the sampling needs to be increased drastically. Another example, is when the vehicle travels on a roadway in a desert landscape without any objects at all present, the sampling can be kept at minimum, for example, instead of 1000 pixels (which is the full size of the example sensor), 10-15 pixels can be sampled.

At step 307, the selected abstract model is updated, i.e the context and content information of the abstract models is updated with data from received sensor data, for example, with task relevant data.

At step 308, the classification of sampling of sensor data is adapted based on selected abstract model.

At step 309, task information is provided to a control unit of the vehicle, for example, the ECU 20, which may send instructions to different other units or systems of the vehicle such as to the the braking system and/or steerings system 23. However, this step is not necessarily executed after step 308 but can be executed in connection with other step and/or continuously during the control loop 300.

Thereafter, the control loop 300 determines, at step 310, if the task has been completed or accomplished, if not, the loop 300 returns to step 304. If yes, the control loop 300, closes or terminates the task, at step 312.

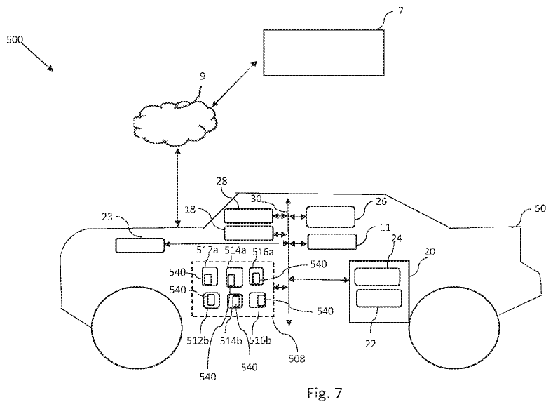

Referring now to FIG. 7, an operating environment 500 for another embodiment of the present invention will be discussed. The operating environment 500 is implemented in a vehicle 50 and a server 7 located externally of the vehicle 50 or a cloud based solution 7 located externally of the vehicle 50.

These elements may be communicatively connected or coupled to a network 9. Although only one vehicle 50 and one server or cloud based solution and one network 9 are shown in FIG. 7, in practice the operating environment may include more vehicles, servers and networks. The network 9 may be a conventional type, wired or wireless, and may have numerous different configurations including a star configuration, token ring configuration or other configurations. Furthermore, the network 9 may also include a local area network (LAN), a wide area network (WAN) (e.g. the Internet), or other interconnected data paths across which multiple device and entities may communicate. The network 9 may also be coupled to or may include portions of telecommunications networks for sending data in a variety of different protocols. For example, the network 9 may include Bluetooth® communication networks or cellular communications networks for sending or receiving data including data including via short messaging service (SMS), multimedia messaging service (MMS), hypertext transfer protocol (HTTP), direct data connection, wireless application protocol (WAP), e-amil, DSRC, full-duplex wireless communication, etc. Further, the network may also include a mobile data network that may include 3G, 4G, LTE, VoLTE or any other cellular network, mobile data network or combination of mobile data networks. The network 9 may also include one or more IEEE 802.11 wireless networks.

The vehicle 50 may include a car, a truck, a sports utility vehicle (SUV), a bus, a semi-truck, adrone, or any other roadway-based conveyance. A road-based conveyance is hardware device that traverses the top surface of a roadway.

In embodiments, the vehicle 50 may include an autonomous vehicle, a semi-autonomous vehicle or Highly Automated Vehicle (“HAV”). For example, the vehicle 50 may include an ADAS system 11 which is operable to make the vehicle 50 an autonomous vehicle. An HAV is a vehicle 50 whose ADAS system 11 operate at level 3 or higher as defined by the NHTSA in the policy paper “Federal Automated Vehicles Policy: Accelerating the Next Revolution in Road-way safety”, published in September 2016.

The vehicle 50 may further include a sensor set 508 comprising camera sensors 512a and 512b, one or more LIDAR sensors 514a and 514b, and one or more radar sensors 516a and 516b. In the present example, two camera sensors, two LIDAR senors, and two radar sensors are shown. However, any number of sensors may be included and a vehicle may often have 10-15 camera sensors as an example. It should also be understood that the location of the sensors in the figures only are schematical, i.e. for illustrative purposes only, and may be located at any suitable location in the vehicle 5 in order to satisfy its functions and purposes.

Furthermore, the vehicle 50 may include an acuator set 18, a hardware ECU 20, a communication unit 26, and GPS unit 28. The ECU 20 in turn include a processor 22, and a memory 24. These elements of the vehicle 5 is communicatively coupled to one another via a bus 30. The memory 24 may be a non-transitory computer readable memory. The memory 24 stores instructions or data that can be executed by the processor 22. The instructions or data contain code for performing the techniques described herein. In some embodiments the memory 24 may be a dynamic random access memory (DRAM) device, a static random access memory (SRAM) device, flash memory, or some other memory device. In some embodiments, the memory 24 also includes a non-volatile memory or similar permanent storage device and media including a hard disk drive, a floppy disk drive, a CD-ROM device, a DVD-ROM device, a DVD-RAM device, a DVD-RW device, a flash memory device or some other mass storage device for storing information on a more permanent basis.

The actuator set 18 includes one or more actuators of the vehicle 50. For example, the actuator set 18 includes one or more of the following: one or more hydraulic actuators, one or more electric actuators and one or more thermal actuators.

The processor 22 may include an arithmetic logic unit, a microprocessor, a general purpose controller or some other other processor array to perform computations and provide electronic display signals to a display device. The processor 22 processes data signals and may include various computing architectures including a complex instructions set computer (“CISC”) architecture, a reduced instruction set computer (“RISC”) architecture or an architecture implementing a combination of instructions sets. Although FIG. 1 shows a single processor in the ECU multiple processors may be included.

The sensor set 508 includes camera sensors 512a, 512b, LIDAR sensors 514a, 514b and radar sensors 516a, 516b. However, it may further include millimeter wave radar, a speed sensor, a laser altimeter, a navigation sensor (e.g. a global positioning system sensor of the GPS unit), an infrared detector, a motion detector, a thermostat, a sound detector, a carbon monoxide detector, an oxygen sensor, a mass air flow sensor, an engine coolant temperature sensor, a throttle position sensor, a crank shaft position sensor, an automobile engine sensor, a valve timer, an air-fuel ratio meter, a blind spot meter, a curb feeler, a defect meter, a Hall effect sensor, a manifold absolute pressure sensor, a parking sensor, a radar gun, a speedometer, a transmission fluid temperature sensor, a turbine speed sensor, a variable reluctance sensor, a wheel speed sensor, and any type of automotive sensor that may be present in an HAV.

The sensor set 508 may be operable to record data (hereinafter “sensor data”) that described one or more measurements of the sensors included in the sensor set 508.

As indicated above, the sensor set 508 include sensors that are operable to measure the physical environment outside the vehicle 50. For example, the sensor set 508 may record one or more physical characteristics of the physical environment that is proximate to the vehicle 50. The measurements recorded by the sensors are described by sensor data may be stored in the memory 24 or in sensor data processing unit 540, which will be described below.

The sensor data may describe the physical environment proximate to the vehicle at one or more times. The sensor data may be timestamped by the sensors of the sensor set 508.

The sensor set 508 includes as, described above, sensors 512a, 512b, 514a, 514b, 516a, and 516b that are operational to measure, among other things: the physical environment, or roadway environment where the vehicle 50 is located as well as the static objects within this physical environment, the dynamic objects within the physical environment and the behaviour of these objects, the position of the vehicle 50 relative to static and dynamic objects within the physical environment (e.g. as recorded by one or more of range-finding sensors such as LIDAR) and the weather within the physical environment over time and other natural phenomena within the physical environment over time, coefficients of friction and other variables describing objects.

The communication unit 26 transmits and receives data to and from the network 9 or to another communication channel. In some embodiments, the communication unit 26 may include a DSRC transceiver, DSRC receiver and to the hardware or software necessary to make the vehicle 5 a DSRC-enabled device.

In embodiments of the present invention, the communication unit 26 includes a port for direct physical connection to the network 9 or to another communication channel. For example, the communication unit 26 includes a USB, SD, CAT-5, or similar port for wired communication with the network 9. In some embodiments, the communication unit 26 includes a wireless transceiver for exchanging data with the network 9 or other communication channel using one or more wireless communication methods, including IEEE 802.11; IEEE 802.16, BLUETOOTH®, EN ISO 14906:2004 Electronic Fee Collection Application interface EN 11253:2004 Dedicated Short-Range Communication —Physical Layer using microwave at 5.8 GHz (review); EN 12795:2002 Dedicated Short-Range Communication (DSRC)—DSRC data link layer: Medium Access and logical link control (review); EN 12834:2002 Dedicated Short-Range Communciation—Application layer (review); EN 13372:2004 Dedicated Short-Range Communciaiton (DSRC)—DSRC profiles for RTTT aoolicatoins (review).

In some embodiments, the communication unit 26 includes a cellular communication transceiver for sending and receiving data over a cellular communications network including via short messaging service (SMS), multimedia messaging service (MMS), hypertext transfer protocol (“HTTP” or “HTTPS” if the secured implementation of HTTP is used), direct data connection, WAP, email or any other suitable type of electronic communication. In some embodiments, the communication unit 26 also provides other conventional connections to the network 9 for distribution of files or media using standard network protocols including TCP/IP, HTTP, HTTPS and SMTP, millimeter wave, DSRC, etc.

The vehicle further includes one or more driving systems 23, such as, braking system and steering system 23.

In this embodiment of the present invention, the sensors 512a, 512b, 514a, 514b, 516a, and 516b include a sensor data processing unit 540 is arranged in the vehicle 50 and may be communicatively coupled to, via the bus 30, the electronic control unit 20, as well as to other units of the vehicle such as the GPS unit 28 and communication unit 26. Preferably, each sensor includes one sensor data processing unit 540.

The sensor data processing unit 540 include a processor, such as an arithmetic logic unit, a microprocessor, a general purpose controller or some other other processor array to perform computations and provide electronic display signals to a display device. The data processing unit 40 processes data signals and may include various computing architectures including a complex instructions set computer (“CISC”) architecture, a reduced instruction set computer (“RISC”) architecture or an architecture implementing a combination of instructions sets. The sensor data processing unit 540 may further include a memory. The memory may be a non-transitory computer readable memory. The memory stores instructions or data that can be executed by the sensor data processing unit 540. The instructions or data contain code for performing the techniques described herein. In some embodiments the memory may be a dynamic random access memory (DRAM) device, a static random access memory (SRAM) device, flash memory, or some other memory device. In some embodiments, the memory also includes a non-volatile memory or similar permanent storage device and media including a hard disk drive, a floppy disk drive, a CD-ROM device, a DVD-ROM device, a DVD-RAM device, a DVD-RW device, a flash memory device or some other mass storage device for storing information on a more permanent basis.

The sensor data processing unit 540 may be configured to receive tasks, each task being associated with task information. A task may for example be navigation to a certain location, area or place, e.g. defined by map coordinates and GPS coordinates. The task information may be information related to the task and needed to solve the task. For example, it may be coordinates, or information related to available roads, barriers along the road. The task relevant data is data from sensors that is relevant to an ongoing task and may be added to the task relevant information. For example, it may be information that describes the roadway environment outside the vehicle 50, the location of remote vehicles, objects in the roadway or in the surroundings of the roadway relative the vehicle 50, operational status of the vehicle 50 (e.g. kinematic data for the vehicle 50), Map data and GPS data.

In some embodiments, the operational status of the vehicle 50 is information in the sensor data that described one or more of the following. Kinematic data for the vehicle, the latitude and longitude of the vehicle, the heading of the vehicle, braking system data (e.g. whether breaks are engaged), the elevation of the vehicle, the current time for the vehicle, the speed of the vehicle, the steering angle of the vehicle, the acceleration of the vehicle, the path history of the vehicle, an estimate of the further path of the vehicle.

The GPS data may include digital data that describes the geographic location of the vehicle, for example, latitude and longitude with lane-level accuracy.

The map data may include digital data that describes, for different combinations of latitude and longitude as indicated by GPS data, different geographical features of the roadway environment indicated by the GPS data such as the presence of curves in the roadway, whether this is a bumpy road, the average vehicular speeds along the roadway at different times of day etc.

Abstract model is a simplified model or description of a scene or environment based on vectors or surfaces. The abstract model may contain information about the scene, context information. In case of a road, it may be, for example, type of road. Further, the abstract model may include content information, which, in case of the road, may be information about bends, and/or crossings. In FIGS. 6a and 6b, examples of such abstract models are shown. FIG. 6a shows an abstract model put together of four surfaces or planes 401, 402, 403, and 404. FIG. 6b shows another example, put together of a number of surfaces or planes 401, 402, 403, and 404 shown in FIG. 6a. The planes or surfaces are formed from sensors data or information from one or several sensors and location information.

The sensor data processing unit 540 may further be configured to classify sampling of sensor data according to task information and a selected abstract model in order to sample task relevant data, wherein an abstract model is selected from a set of abstract models associated with context and content information, the abstract models including models describing traffic scenes and the context and context information describing traffic scene environment. Moreover, the sensor data processing unit 540 is configured to evaluate the selected abstract model based on received sensor data whether to maintain the selected abstract model or to select a new abstract model, the received sensor data representing an actual traffic scene, and to adapt the classification of sampling of sensor data based on selected abstract model.

The sensor data processing unit 540 is configured to continuously collect task relevant data based on received sensor data, adding the task relevant data to the task information and providing task information to an electronic control unit 20 of the vehicle 50. Further, the sensor data processing unit 540 may be configured to update the context and content information of the abstract models with data from task relevant data.

The sensor data processing unit 540 comprises a sensor data handling module 41 as shown in FIG. 2 including six main components 44-49. The components include a sensing component 44, an abstracting component 45, a learning component 46, a prediction component 47, a projecting component 48, and a decision component 49 which have direct or indirect interaction with each other as described above in connection with FIG. 2.

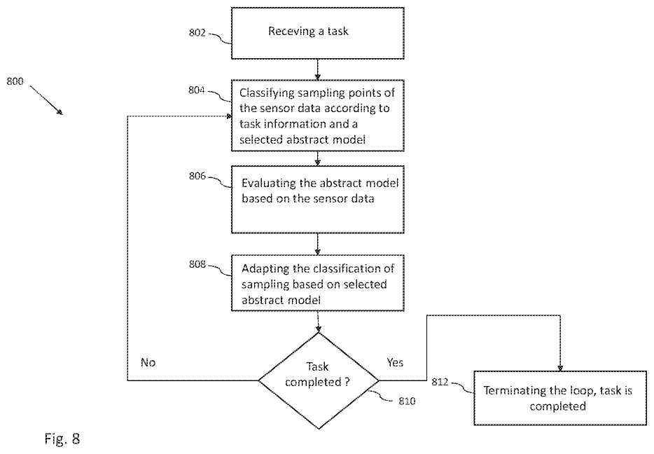

With reference now to FIG. 8, a flow chart describing a method or control loop 800 according to embodiments of the present invention will be discussed. The steps taking place in the sensor data handling module 41 and its components (described above with reference to FIG. 2) according to an example embodiment of the present invention are accordingly illustrated in FIG. 3

At step 802, a task is received, which may be navigating the vehicle 50 to a certain location. For example, it may be a passenger of the vehicle 50 entering the task into a monitor module of the vehicle 50. Preferably, each sensor receives the task, or the sensor data processing unit 540 of each sensor receives the task. At step 804, sampling of sensor data is classified according to the task information and a selected abstract model in order to sample task relevant data in each respective sensor, wherein the selected abstract model is selected from a set of abstract models associated with context and content information, the abstract models including models describing traffic scenes and the context and context information describing traffic scene environment. The abstract models are stored locally in sensors 508 of the vehicle, and/or in a memory 24 of the electronic control unit 20 and/or externally of the vehicle in a server based memory 7 or cloud based memory 7. A sensor can select an abstract model starting from a received position indication, for example, received over the network 9 or the GPS 28.

Depending upon the sensed sensor data in respective sensor 508, the sampling in the respective sensors 508 can be increased, maintained or decreased. For example, in case of an alert situation, e.g. an animal is detected in front of the vehicle, the sampling needs to be increased drastically. Another example, is when the vehicle travels on a roadway in a desert landscape without any objects at all present, the sampling can be kept at minimum, for example, instead of 1000 pixels (which is the full size of the example sensor), 10-15 pixels can be sampled.

Thereafter, at step 806, the selected abstract model is evaluated based on sensor data in order to decide whether to maintain the selected abstract model or to select a new abstract model, the sensor data representing an actual traffic scene. At step 808, the classification of sampling of sensor data in respective sensor 508 is adapted based on selected abstract model. Thereafter, the control loop 800 determines, at step 810, if the task has been completed or accomplished, if not, the loop 800 returns to step 804. If yes, the control loop 800, closes or terminates the task, at step 812.

Although exemplary embodiments of the present invention have been shown and described, it will be apparent to those having ordinary skill in the art that a number of changes, modifications, or alterations to the inventions as described herein may be made. Thus, it is to be understood that the above description of the invention and the accompanying drawings is to be regarded as a non-limiting example thereof and that the scope of protection is defined by the appended patent claims.

What is claimed is:

1. A method for sampling of task relevant data in sensors in a vehicle, a number of sensors being arranged in the vehicle, the method comprising:
providing a task to a data processing unit arranged in the vehicle, the task being associated with task information;
providing a set of abstract models associated with context and content information, the abstract models including models describing traffic scenes, and the context and context information describing traffic scene environment;
classifying sampling points of sensor data according to the task information and a selected abstract model in order to sample task relevant data;
evaluating the selected abstract model based on received sensor data whether to one of maintain the selected abstract model and to select a new abstract model, the received sensor data representing an actual traffic scene; and
adapting the classification of sampling of sensor data based on the selected abstract model.

2. The method according to claim 1, further comprising:
continuously collecting task relevant data based on received sensor data; adding the task relevant data to the task information; and
providing task information to an electronic control unit of the vehicle.

3. The method according to claim 1, further comprising updating the context and content information of the abstract models with data from task relevant data.

4. The method according to claim 1, wherein the sensors include at least one of:
at least one camera;
at least one LIDAR; and
at least one radar unit.

5. A method for sampling of task relevant data in sensors in a vehicle, a number of sensors being arranged in the vehicle, the method comprising:
providing a task to a sensor data processing unit arranged in a sensor of the vehicle, the task being associated with task information;
providing a set of abstract models associated with context and content information, the abstract models including models describing traffic scenes and the context and context information describing traffic scene environment;
classifying sampling points of sensor data according to the task information and a selected abstract model in order to sample task relevant data;
evaluating the selected abstract model based on sensor data sensed in the sensor whether to one of maintain the selected abstract model and to select a new abstract model, the sensor data representing an actual traffic scene; and
adapting the classification of sampling of sensor data in the sensor based on the selected abstract model.

6. The method according to claim 5, further comprising:
continuously collecting task relevant data based on received sensor data; adding the task relevant data to the task information; and
providing task information to an electronic control unit of the vehicle.

7. The method according to claim 5, further comprising updating the context and content information of the abstract models with data from task relevant data.

8. The method according to claim 5, wherein the sensors include at least one of:
at least one camera;
at least one LIDAR; and
at least one radar unit.

9. A system for sampling of task relevant data in sensors in a vehicle, a number of sensors being arranged in the vehicle, the system comprising:
a data processing unit arranged in the vehicle, the data processing unit being configured to receive tasks, each task being associated with task information, the data processing unit being configured to:
classify sampling points of sensor data according to task information and a selected abstract model in order to sample task relevant data, an abstract model being selected from a set of abstract models associated with context and content information, the abstract models including models describing traffic scenes, and the context and context information describing traffic scene environment; and
evaluate evaluating the selected abstract model based on received sensor data and whether to one of maintain the selected abstract model and to select a new abstract model, the received sensor data representing an actual traffic scene; and
adapt the classification of sampling of sensor data based on selected abstract model.

10. The system according to claim 9, wherein the data processing unit is further configured to:
continuously collect task relevant data based on received sensor data; add the task relevant data to the task information; and
provide task information to an electronic control unit of the vehicle.

11. The system according to claim 9, wherein the data processing unit is further configured to update the context and content information of the abstract models with data from task relevant data.

12. The system according to claim 9, wherein the sensors include at least one of:
at least one camera;
at least one LIDAR; and
at least one radar unit.

13. A system for sampling of task relevant data in sensors in a vehicle, a number of sensors being arranged in the vehicle, at least one sensor including:
a data processing unit, the data processing unit being configured to:
receive tasks, each task being associated with task information;
classify sampling points of sensor data according to task information and a selected abstract model in order to sample task relevant data, an abstract model being selected from a set of abstract models associated with context and content information, the abstract models including models describing traffic scenes, and the context and context information describing traffic scene environment; and
evaluate the selected abstract model based on sensor data whether to one of maintain the selected abstract model and to select a new abstract model, the sensor data representing an actual traffic scene; and
adapt the classification of sampling of sensor data based on selected abstract model.

14. The system according to claim 13, wherein the sensor data processing unit is further configured to:
continuously collect task relevant data based on received sensor data; add the task relevant data to the task information; and
provide task information to an electronic control unit of the vehicle.

15. The system according to claim 13, wherein the sensor data processing unit is further configured to update the context and content information of the abstract models with data from task relevant data.

16. The system according to claim 13, wherein the sensors include at least one of:
at least one camera;
at least one LIDAR; and
at least one radar unit.

17. A sensor for sampling of task relevant data in a vehicle, the sensor including:
a data processing unit, the data processing unit being configured to:
receive tasks, each task being associated with task information;
classify sampling points of sensor data according to task information and a selected abstract model in order to sample task relevant data, an abstract model being selected from a set of abstract models associated with context and content information, the abstract models including models describing traffic scenes, and the context and context information describing traffic scene environment; and
evaluate the selected abstract model based on sensor data whether to one of maintain the selected abstract model and to select a new abstract model, the sensor data representing an actual traffic scene; and
adapt the classification of sampling of sensor data based on selected abstract model.

18. The sensor according to claim 17, wherein the sensor data processing unit is further configured to:
continuously collect task relevant data based on received sensor data;
add the task relevant data to the task information; and
provide task information to an electronic control unit of the vehicle.

19. The sensor according to claim 17, wherein the sensor data processing unit is further configured to update the context and content information of the abstract models with data from task relevant data.
